(19) United States
(12) Patent Application Publication
(10) Pub. No.: US 2024/0211669 A1
(43) Pub. Date: Jun. 27, 2024

(54) AGILE AND ITERATIVE METHODOLOGY TO DESIGN CUSTOM ARCHITECTURES FOR LOW INTERFERENCE CONTENTION WITH PMCS

(71) Applicant: Rockwell Collins, Inc., Cedar Rapids, IA (US)

(72) Inventors: Gonzalo Salinas Hernando, Cork City (IE); Alejandro Garcia Gener, Cork (IE); Raul de la Cruz Martinez, Rochestown (IE)

(21) Appl. No.: 18/392,297

(22) Filed: Dec. 21, 2023

(30) Foreign Application Priority Data
Dec. 23, 2022 (EP) 22216446.9

(51) Int. Cl. G06F 30/331

(52) U.S. Cl. CPC G06F 30/331

(57) ABSTRACT

A method for designing custom microarchitectures includes proposing an initial microarchitecture comprising at least two intellectual property, IP, components and at least one interference channel, ICh, based on final requirements of the microarchitecture. The method further includes prototyping the proposed microarchitecture; executing at least one μBenchmark on the prototyped microarchitecture; monitoring at least one Performance Monitoring Counter, PMC, resulting from the execution of the at least one μBenchmark to identify whether the prototyped microarchitecture satisfies timing and contention requirements of the microarchitecture. If all timing and contention requirements are met, the prototyped custom microarchitecture is accepted as the custom microarchitecture. If they are not met, a source of contention is identified by identifying bottlenecks in the at least one PMC during the execution of the at least one μBenchmark and the proposed microarchitecture is adapted to mitigate the contention scenario or modify a Hardware Performance Monitor unit.

### CROSS-REFERENCE TO RELATED APPLICATIONS

The present application claims the benefit of European Patent Application No. EP22216446.9, entitled AGILE AND ITERATIVE METHODOLOGY TO DESIGN CUSTOM ARCHITECTURES FOR LOW INTERFERENCE CONTENTION WITH PMCS, filed on Dec. 23, 2022, which is incorporated by reference in the entirety.

### TECHNICAL FIELD

This invention relates to agile and iterative methodology to design safe custom microarchitectures with low interference and contention profiles using performance monitoring counters.

### BACKGROUND

There has been a recent movement from single core processors to processors with multiple processing cores within the same processor device, which can provide a significant performance increase with a similar amount of power consumption.

As such, a wide range of multi-processor system-on-chip (MPSoC) architectures targeted for embedded applications have appeared on the market over the last years. This kind of MPSoC includes multiple processing cores, either homogeneous or heterogeneous, on the same die. Multi-core processors (MCP) with two or more processing cores overcome the frequency scaling, power consumption and heat dissipation problems associated with single core processors, all whilst the effective throughput is increased.

As such, MCPs have delivered significant performance improvements over traditional single-core processors. However, their use in safety-critical systems (such as avionics systems) poses some unique challenges that are otherwise not present in typical single-core processors, which otherwise run a single process at a time.

For efficiency, MCP designs include shared resources on the device. Processor cores in MCPs are typically tightly or loosely coupled, sharing intermediate memory systems (cache hierarchies) and interconnection buses in order to access main memory and external input/output (I/O) devices. MPSOC architectures, in order to simplify board layout design, integrate more components onto the device to reduce the physical footprint.

Depending on the hardware implementation, tasks running on different cores (i.e. different processes or threads) may share some of these resources while they are being executed. However, the simultaneous execution of tasks on a parallel computer architecture can cause contention in the form of delays accessing certain shared resources and thus interference and variability on their typical execution time. Contention can be a particularly serious issue when it comes to real-time and/or safety-critical systems.

In safety-critical applications, for example in avionics systems such as those for helicopters or other aircraft, there are specific requirements that stem from the concurrent performance of tasks in MCPs. These include application isolation and determinism. Application isolation relates to the separation of the tasks of one application from the rest of the running processes, e.g. to shield the application from exploits. Determinism is the property of, when given a particular input, always producing the same output, and always passing through the same sequence of states. Furthermore, in such situations and for certification, it is typically necessary to know the actual execution time of a given set of tasks, which cannot be known without knowing the structure of a MCP and any potential contention between the tasks.

In any von Neumann architecture, processors in MPSoCs are tightly coupled (i.e. highly dependent on one another, such that changes in one module create a ripple effect in the performance of others) or loosely coupled (i.e. weakly associated with one another, such that changes in each component have limited effect in the performance of the others). They have intermediate memory systems (cache hierarchies) and interconnection buses to access main memory and external I/O devices. Depending on the specific hardware implementation, tasks running on different cores (e.g. processes or threads) may share some of these resources while they are being executed.

For example, FIG. 1 shows an example MPSoC 100 and the resources that are shared between four separate cores, specifically the two Level 2 shared cache banks, and the common interconnect network. The simultaneous execution of tasks on different cores on a parallel computer architecture can cause contention in the form of delays accessing certain shared resources and thus interference and variability on their typical execution time.

Specifically, in the real-time embedded system realm for avionics, task interference due to the contention on shared resources poses a big challenge for determinism, and therefore, certification. The uncertainty of not knowing beforehand the actual execution time on an MCP hinders certification on the avionics scope.

In this way, when providing an MCP for safety-critical uses, it is generally necessary to ensure that multiple applications running on a single core do not interfere with another application's performance, and additionally that each core will execute its designated tasks in the proper sequence at all times, and within an acceptable time period.

Multi-core semiconductor manufacturers designing MCPs for the commercial market tend to optimize their processors for performance, not safety and isolation, and additionally do not tend to publish details of the internal structure of their MCPs. In this way, it is difficult to predict the kinds of scheduling conflicts that might occur. This can make it challenging to design software for execution by such processors, especially in safety-critical contexts

Manufacturers of commercial off-the-shelf (COTS) systems do provide Hardware Performance Monitors (HPM) in their designs to allow some degree of visibility of specific events over the system, to support verification and runtime testing. These HPM units incorporate Performance Monitoring Counters (PMCs) that are used to build software tests by interrogating their assigned registers over time.

A representative platform of HPM capabilities is the NXP T2080 platform, which is an MCP architecture that has been broadly adopted for embedded systems to implement safety-critical applications. The NXP T2080 processor comprises 4 cores, each owning its private instruction and data L1 cache. A level 2, L2, banked cache of 2 MB is shared among cores and connected to the memory controller through the CoreNet Coherence Fabric (CCF). Its HPM unit allows to monitor L2 and CCF events through a set of PMCs.

However, very often, such general-purpose architectures need to balance the number of events and registers to manage complexity and space, which limits their usefulness. In addition, software-based tests and register gathering add overhead to the already complex applications.

As a result, the design and customization of microarchitectures by Tier-1 suppliers (assemblers) is gaining traction against the use of COTS systems. This presents the ability to specially adapt the microarchitecture to the customer needs, whilst allowing for a fuller understanding of the limitations of the hardware implementation. This is usually not possible in the case of COTS-based microprocessors, where manufacturers keep their intellectual property (IP) cores proprietary, and rarely reveal their HW implementations in detail to the public in the Technical Reference Manuals (TRM). The lack of this information enforces assemblers to conduct large and costly campaigns to reveal any hidden implementation to fully understand the behaviour of the System on Chip (SoC) and be able to certify the final product regarding determinism.

Even with such options, there still exists a need to more efficiently design, assess, validate, mitigate issues and repeat prototyping (if necessary) in order to create custom microarchitectures based on their specific requirements. In addition, there exists a need to be able to monitor the processes being executed on an MCP in order to quickly and accurately identify anomalies in their nominal execution (i.e. if a given task does not run as it was expected to) and identify potential malware.

### SUMMARY

According to a first aspect, there is provided a method for designing custom microarchitectures, the method comprises proposing an initial microarchitecture comprising at least two intellectual property, IP, components and at least one interference channel, ICh, based on final requirements of the microarchitecture; a) prototyping the proposed microarchitecture; b) executing at least one μBenchmark on the prototyped microarchitecture; and c) monitoring at least one Performance Monitoring Counter, PMC, on each IP component resulting from the execution of the at least one μBenchmark to identify whether the prototyped microarchitecture satisfies timing and contention requirements of the microarchitecture.

The method comprises step d) If all timing and contention requirements are met by the prototyped microarchitecture, then the prototyped microarchitecture may be accepted as the custom microarchitecture. However, if all timing and contention requirements are not met, then a source of contention is identified by identifying bottlenecks in the at least one PMC during the execution of the at least one μBenchmark, and the proposed microarchitecture is adapted so as to mitigate the contention scenario, and/or modifying a Hardware Performance Monitor, HPM, unit associated with at least one of the IP components so as to define at least one new PMC. Then steps a) to d) may be repeated starting from the adapted proposed microarchitecture, hence resulting in a new prototyped microarchitecture which is then tested to see if all timing and contention requirements are met. This may be repeated as many times as necessary (with an adapted proposed microarchitecture each time, and therefore a new prototyped microarchitecture) until all timing and contention requirements are met, at which point, the latest prototyped microarchitecture (i.e. the microarchitecture that satisfies all of the timing and contention requirements) may be accepted as the custom microarchitecture.

In this way, such a method defines an iterative method that allows for fulfilment of the requirements on interference and contention of a final SoC configuration. In doing so, it is possible to specifically design a microarchitecture to overcome the non-deterministic behavior that SoCs display when multiple computational units are accessing to the shared resources. Such a method emphasises in a refinement and iterative process where the main objective is to minimize or reduce the potential contention scenarios. In addition, the iterative method allows for new PMCs to be defined during testing/prototyping of a microarchitecture, thereby allowing for more accurate characterisation of the microarchitecture.

Essentially, there is defined a method where an initial microarchitecture can be proposed, prototyped and tested for whether it satisfies testing and contention requirements of the microarchitecture. Based on these results, the microarchitecture may be modified, and tested again, and the process repeated until all requirements are met and a custom microarchitecture can be proposed.

As would be appreciated, μBenchmarks are synthetic applications specially designed to stress different shared resources to reveal and measure the system behaviour under contention scenarios. For both heterogenous and homogeneous architectures, these interference μBenchmarks may be capable of triggering the contention from all of the interfering actors accessing the shared resources in the final SoC (e.g. cores, DMAs or any master peripheral). An IP component is a master/interfering device in the proposed architecture.

The proposed microarchitecture may comprise mi IP components, and cj IChs, and step b) may comprise executing n μBenchmarks, n being equal to mi×cj, each μBenchmark being configured to stress a specific ICh for a given IP component of the prototyped microarchitecture. This allows for a complete characterisation of all interference channels of a prototyped microarchitecture.

The step of adapting the proposed architecture may comprise identifying a source of contention on the prototyped microarchitecture, and modifying a Hardware Performance Monitor, HPM, unit associated with at least one of the IP components so as to define at least one new PMC based on the identified source of contention on the prototyped microarchitecture to allow more accurate characterisation of the IChs. In this way, the monitored PMCs can be modified between each iteration of the method so as to result in a more accurate characterisation of the interference channels.

The step of adapting the microarchitecture so as to mitigate the contention scenario may comprise identifying a source of contention on the prototyped microarchitecture, and adapting the microarchitecture so as to mitigate the identified source of contention. For example, the step of adapting the microarchitecture may comprise at least one of the following: shared bus isolation, cache partitioning, cache resizing, separating peripherals, customizing instructions. This allows for targeted modifications based on the areas in which excessive contention is identified.

Step a) may comprise defining a high-level circuit description in Chisel, and converting the higher level circuit description to Verilog for synthesis and/or simulation. By using Hardware Construction Languages (HCLs) as a placeholder framework allows for a fast prototyping, thereby reducing the cost-effort factor in prototyping new microarchitectures.

Step a) may comprise prototyping the microarchitecture in a simulated environment, in which case, steps b) and c) may be performed within the simulated environment.

Alternatively, step a) may comprise synthesising the microarchitecture, and steps b) and c) may then be performed on the synthesised microarchitecture. The synthetized microarchitecture may be a Custom System on Chip, SoC, architecture in a field-programmable gate array, FPGA, circuit.

The initial microarchitecture may be proposed based on at least one of the following requirements for the final microarchitecture: Type of core, Core size, Number of cores, floating-point-unit (FPU), Custom instructions, Cache size, L2 cache, double data rate (DDR) controller, memory management unit (MMU), physical memory protection (PMP), DTIM/ITIM (tightly coupled memory), On-chip scratchpad memory, Branch prediction capabilities, Number of PMCs, Redundancy on memory-mapped input/outputs (MMIOs), MM (memory mapped) peripherals for processing, or MM peripherals for communication and actuation (e.g., I2C, SPI, UART, ARINC-429, GPIOs, PWM).

At least one of the following PMCs may be monitored: cache hits and misses, number of instructions retired, number of clock cycles, number and types of transactions through the system bus, number of cycles the HW resource has been idle, stalled or busy.

At least one μBenchmark may be selected from a database of μBenchmarks.

According to a second aspect, there is provided a method for manufacturing custom microarchitectures, the method comprising designing a custom microarchitecture as described above, manufacturing the custom microarchitecture.

According to a third aspect, there is provided custom microarchitecture manufactured by the second aspect. The custom microarchitecture may be for use in avionics.

### BRIEF DESCRIPTION OF THE DRAWINGS

Certain examples of the disclosure will now be described, by way of example only, with reference to the accompanying drawings, in which:

FIG. 1 is a schematic diagram of an example MPSoC with multiple computational units, shared memory hierarchies and interconnection buses with interference channels and possible contention scenarios.

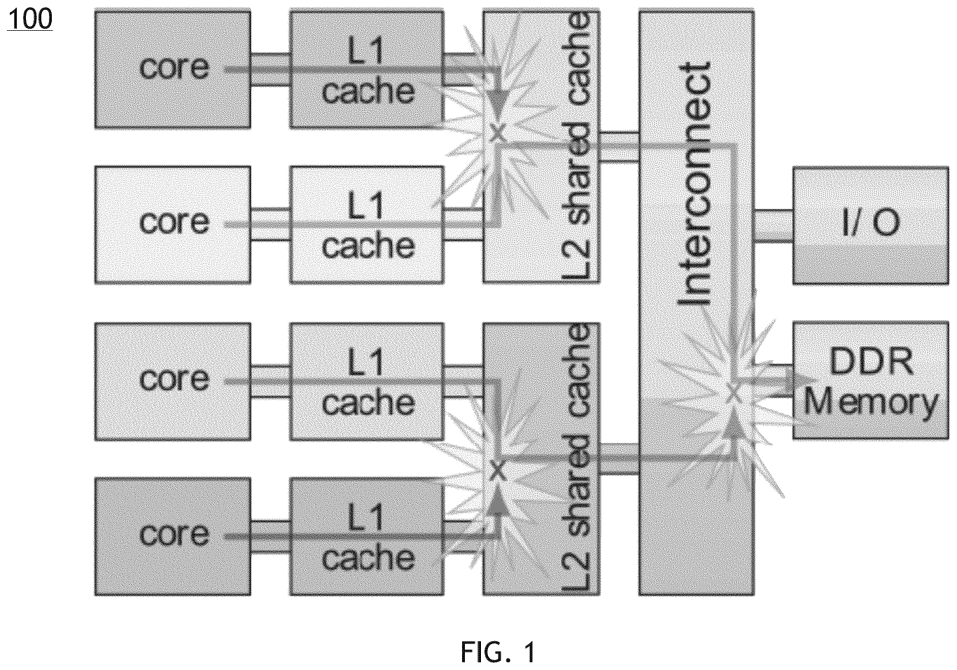

FIG. 2 is a sample generation flow that converts Scala and Chisel descriptions into low level Verilog, in accordance with one or more embodiments of the present disclosure.

FIG. 3 is a flow chart describing an agile and iterative methodology to design custom architectures for low interference contention with PMCs, in accordance with one or more embodiments of the present disclosure.

FIG. 4 is an illustration of interference channels associated with various IP components, in accordance with one or more embodiments of the present disclosure.

### DETAILED DESCRIPTION

Whilst the methods and systems herein may be described with regards to a multi-core processor (MCP), it would be appreciated that the teaching herein is not limited to only a single processor with multiple cores, but also other multiple processing systems, such as a network of separate processors (i.e. multi-processor systems), and the design process thereof.

As outlined above, the design of custom microarchitectures is gaining traction against the use of COTS systems. In doing so, it is possible to adapt the microarchitecture to the desired application, and by designing a custom microarchitecture, inherently the exact structure of the microarchitecture (and its limitations) will be fully understood. This is not the case in COTS-based microprocessors, where the exact structure often remains proprietary, and the HW implementations are not disclosed. This hinders determinism verification of the system for certification, which is particularly an issue in safety critical applications.

In order to aid designing/customizing microarchitectures, there exist several electronic design automation (EDA) tools. For example, there exist some fast-prototyping frameworks tailored to the design of SoC architectures, such as Chipyard. Essentially, such frameworks allow for the generation of custom architectures starting from high-level parameters, such as the number of number of cores, memory hierarchy, bus protocols, etc. These agile-type frameworks can be ideally used to iteratively generate new HW designs until the interference contention requirement is met.

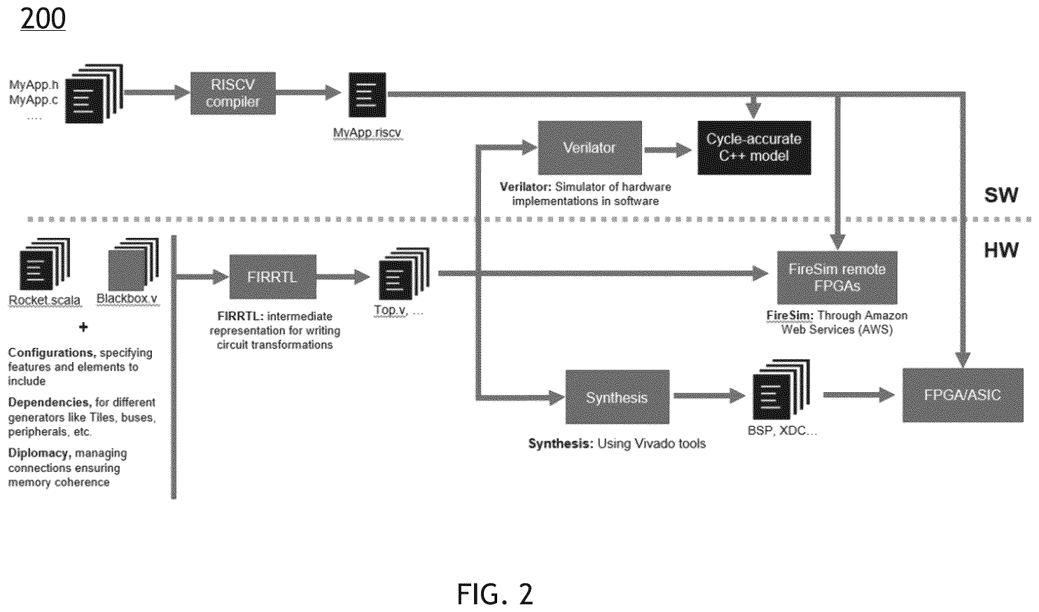

Chipyard is an example of such a framework which uses Chisel (a Hardware Construction Language) to design hardware, together with Scala (a functional and object-oriented programming language) as scripting/glue code to put the different Ips together, and hence convert higher level circuit descriptions (e.g. a specification of hardware) to Verilog for synthesis and simulation. Verilog is an example Hardware Description Language (HDL) which works at Register Transfer Level (RTL). FIG. 2 shows a sample generation flow that converts Chisel and Scala descriptions into low level Verilog, which then may be synthesised and/or simulated.

In this way, the generated HDL code (i.e. the Verilog code) may then be synthesised by a synthesis tool into a gate netlist, which is a specification of physical electronic components and how they are connected together, which can then be placed and routed in order to provide a microarchitecture. Alternatively, the HDL code may be simulated.

As would be appreciated, rather than utilising HCLs, it is possible to directly utilise RTL and then synthesise or simulate the resulting microarchitecture. However, by using HCLs as the placeholder framework allows a fast prototyping, it is possible to reduce the cost-effort factor in prototyping new microarchitectures.

By providing such an HCL framework, it allows for the generation, deployment, and verification of different HW configurations in an iterative way. Such a framework may include tools to generate the Verilog files describing the architecture at RTL level and the deployment of the architecture in a testbench environment, whether that is simulated or synthetized, into a FPGA to enable a closed-loop for the verification and the testing process. Then, the performance of the deployed architecture may be evaluated, and modified as necessary.

Whilst the above details some specific frameworks/languages, it would be appreciated that other such suitable frameworks may be used.

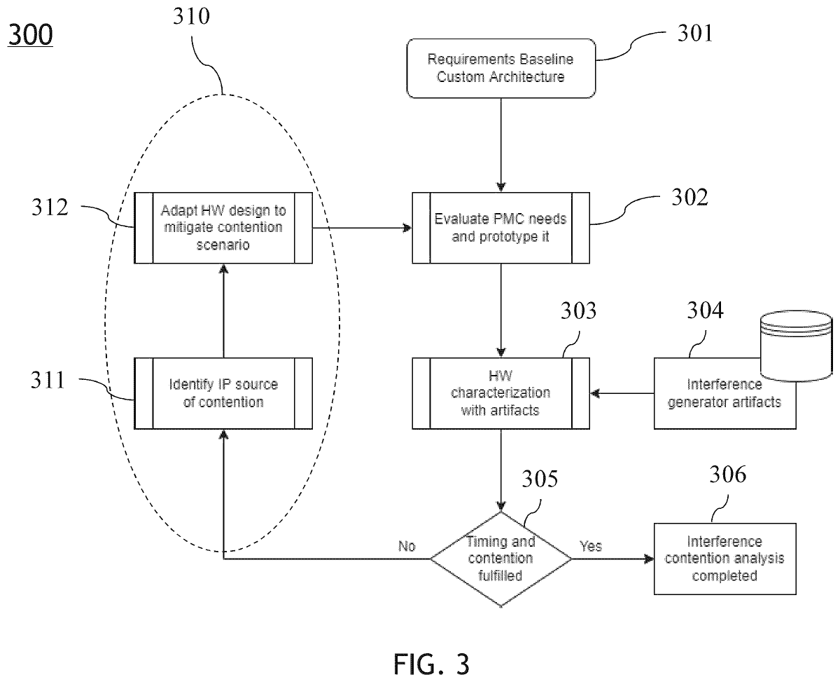

Such an agile and iterative methodology to design custom architectures for low interference contention with PMCs is shown in FIG. 3. The method defines steps to fulfil the requirements on interference and contention of a final SoC configuration. In doing so, it is possible to specifically design a microarchitecture to overcome the non-deterministic behavior that SoCs display when multiple computational units are accessing to the shared resources.

Such a process begins at step 301 by the definition of the initial requirements that are to be imposed on the final Custom SoC system. For example, the initial requirements may include timing and contention objectives apart from the IP block specification (e.g. number of cores, memory hierarchy, bus protocols, DMAs and others). The initial configuration is considered the baseline architecture.

By way of non-limiting example, the initial requirements may comprise one or more of the following requirements:
Type of core: in order (Rocket)/out of order (BOOM)
Core size: small/medium/big
Number of cores
FPU
Custom instructions
Cache size
Optional L2 cache
Optional DDR controller
MMU
PMP
DTIM/ITIM (tightly coupled memory)
On-chip scratchpad memory
Branch prediction capabilities
Number of PMCs
Redundancy on MMIOs
External/Legacy MM peripherals for processing
External/Legacy MM peripherals for communication and actuation (e.g., 12C, SPI, UART, ARINC-429, GPIOs, PWM).

Once an initial model has been generated from the requirement baselines, specific events that allow for the measurement of the timing behaviour and the contention on the shared resources (e.g. bus interconnects) are implemented in the HCL (or as above, directly in the RTL code) at step 302. For example, these events may be implemented in Chisel/Scala using an agile framework, and then the resulting microarchitecture may be prototyped (or simulated). The microarchitecture configuration may then be characterized at step 303 using a set of artifacts that expose the timing behaviour and the potential contention of the development iteration (in the first instance, the baseline architecture).

Then, by evaluating the timing and contention parameters and comparing whether timing and contention requirements are fulfilled at decision block 305, it is possible to apply a feedback loop 310 which, if necessary, identifies the source of contention in step 311 and suggests appropriate modification of the HW design in step 312 as a mitigation to any issues. For example, if a source of contention is identified, the skilled person might modify one or more of the following aspects of the HW design:
Shared bus isolation
Cache partitioning
Cache resizing
Separate peripherals
Custom instructions

Of course, any suitable HW modification may be proposed, and incorporated into the HW design.

Such a feedback loop may be repeated until all timing and contention requirements are fulfilled at decision block 305, at which point the interference contention analysis may be considered completed at step 306.

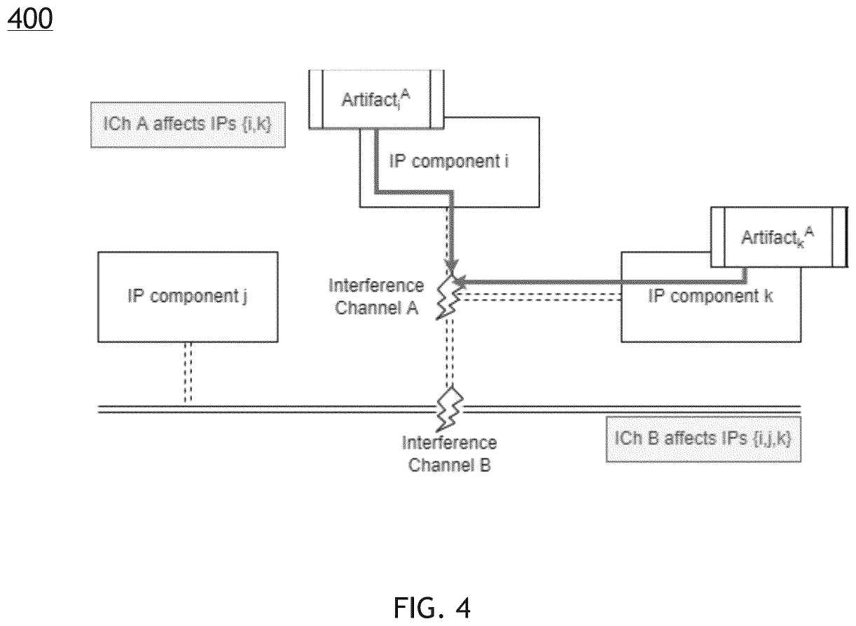

In order to identify (in the testbench, whether synthesised or simulated) potential contention scenarios, a database of interference generator artifacts 304 may be developed. These artifacts, for example μBenchmarks, are synthetic applications specially designed to stress different shared resources to reveal and measure the system behavior under contention scenarios. For both heterogenous and homogeneous architectures, these interference generators/artifacts/μBenchmarks should be capable of triggering the contention from all of the interfering actors accessing the shared resources in the final SoC (e.g. cores, DMAs or any master peripheral). An illustration of various IP components and their associated interference channels may be seen in FIG. 4.

The number of interference generators that should be applied may be determined by the number of master/interfering devices, e.g. IP components (mi), and the number of identified interference channels, ICh (cj). Therefore, in order to have a high coverage of all possible sources of contention, the number of interference generators provided may be mi^{×}cj. Each of these interference generators will stress a specific channel (e.g. ICh A or B shown in FIG. 4) for a given IP component (mi). Such interference may be executed in either a simulated environment resulting from a simulation in a testbench environment, or a synthetized version of the Custom SoC architecture in a FPGA.

As outlined above, one way to characterize the contention on the different IChs is to monitor specific PMCs that are to be implemented and used on the HW. Such counters capture the behavior on the shared resource quantifying the level of contention and the observed delay in the nominal execution time. As such, HPMs may be added to different IP components so as to allow some degree of visibility of specific events over the system, to support verification and runtime testing and allow monitoring of contention. These HPM units incorporate a set of programmable PMC registers that account for specific system events.

PMCs allow gathering of specific system information such as: cache hits and misses, number of instructions retired, number of clock cycles, number and types of transactions through the system bus, number of cycles the HW resource has been idle, stalled or busy. This information is collected through dedicated connections (wires) and gathered by contention artifacts querying the PMC registers on the system over time. By designing a custom microarchitecture, it is possible to customise the HPM units and the gathered PMCs so as to allow for a more accurate characterisation of the contention experienced by the SoC.

As such, the method proposed in FIG. 3 allows for, in step 302, the evaluation of the PMCs that are likely to be required for the proper characterisation of the hardware, and then allows for the tracking of such PMCs in the prototyped hardware.

The PMCs set in an initial architecture may be a set of standard PMCs that are always selected at the beginning, or selected based on likely interference channels according to the requirements of the microarchitecture. For example, it may be that PMCs on the caches or DDR controller are the most useful. Alternatively, at least initially, the maximum number possible of PMCs may be selected, and then only the PMCs displaying the most useful information may be further analysed.

The PMCs to be monitored may be selected by identifying the signals experiencing a bottleneck in the testbench process and using the artifacts executed on the different IP components. By using a process including identifying relevant PMCs resulting from the testing process, the additional latency information obtained during the SoC design may be used to motivate the definition of new PMCs (and the corresponding signals tied to the HPM) for future iterations of the HW to be able to measure the desired event motivating the delay (e.g. device busy, transaction rejected or data requested).

For example, the PMCs experiencing a bottleneck in the testbench process may be identified by first running the workload in isolation, and then running the workload with artifacts/μBenchmarks in parallel (e.g. running on other cores). Then, the latency/contention (time in isolation vs time with parallel workload) may be analysed and from this, the possible IChs may be identified. As would be appreciated, the IChs depend on the type of workload, but most likely will be memory IP components (caches/memory controllers) or other shared peripherals such as a universal asynchronous receiver-transmitter (UART), an accelerator, or a system bus. Following the identification of the possible IChs, PMCs may be created/enabled, which allow for the assessment of the behavior of those interference channels. For example, should it be determined that a UART may be a potential ICh, in the next iteration of the microarchitecture, a PMC measuring communications to/from the UART may be defined.

Therefore, by using an iterative method such as the method shown in FIG. 3, it is possible to modify the monitored PMCs between each pass. For example, in the first pass, a standard set of HPMs monitoring a standard set of PMCs may be utilised by the IP component(s) of the baseline custom architecture in step 302. Then, when the HW is characterised in step 303 by executing the interference generators/artifacts/μBenchmarks, and the subsequent results are analysed, it may be decided that it would be useful to monitor additional and/or other PMCs. Therefore, in step 302 of the subsequent pass, the HPMs of the HW design may be modified and prototyped, in order to track these new PMCs to allow for a more accurate characterisation of the interference channels of the microarchitecture.

As would be appreciated, the structure of the HPM blocks may depend on the complexity of the events to be analysed. For example, the HPM blocks may be composed of sequential state machines, instant combinational logic or simply a conglomerate of signals tied together to compute derived events.

The proposed approach allows for the generation of low interference contention multi-processor systems, and in particular SoC designs. As such, it allows for a faster adoption of highly integrated MPSoCs, and a reduced time to market. Further, certification costs may be reduced due to the minimization of contention scenarios. In addition, the migration of avionics systems from Federated systems to Integrated Modular Avionics are enabled by the adoption of heterogeneous/homogenous SoCs.

It will be appreciated by those skilled in the art that the disclosure has been illustrated by describing one or more specific examples, but is not limited to these examples; many variations and modifications are possible within the scope of the accompanying claims.

1. A method for designing a custom microarchitecture, the method comprising
proposing an initial microarchitecture comprising at least two intellectual property, IP, components and at least one interference channel, ICh, based on final requirements of the microarchitecture;
prototyping the proposed microarchitecture;
executing at least one μBenchmark on the prototyped microarchitecture;
monitoring at least one Performance Monitoring Counter, PMC, resulting from the execution of the at least one μBenchmark to identify whether the prototyped microarchitecture satisfies timing and contention requirements of the microarchitecture;
determining if all timing and contention requirements are met;
upon determining all timing and contention requirements are met, accepting the prototyped microarchitecture as the custom microarchitecture;
upon determining all timing and contention requirements are not met, identifying a source of contention by identifying bottlenecks in the at least one PMC during the execution of the at least one μBenchmark; and
upon identifying a source of contention, at least one of adapting the proposed microarchitecture to mitigate the contention scenario or modifying a Hardware Performance Monitor, HPM, unit associated with at least one of the IP components to define at least one new PMC.

2. The method of claim 1, wherein the proposed microarchitecture comprises mi IP components, and cj IChs, wherein step b) comprises executing n μBenchmarks, n being equal to mi×cj, each μBenchmark being configured to stress a specific ICh for a given IP component.

3. The method of claim 1, wherein the step of adapting the proposed architecture comprises:
identifying a source of contention on the prototyped microarchitecture; and
modifying a Hardware Performance Monitor, HPM, unit associated with at least one of the IP components to define at least one new PMC based on the identified source of contention on the prototyped microarchitecture to allow more accurate characterisation of the IChs.

4. The method of claim 1, wherein the step of adapting the microarchitecture comprises:
identifying a source of contention on the prototyped microarchitecture; and
adapting the microarchitecture to mitigate the identified source of contention.

5. The method of claim 4, wherein the step of adapting the microarchitecture comprises:
at least one of the following: shared bus isolation, cache partitioning, cache resizing, separating peripherals, or customizing instructions.

6. The method of claim 1, wherein step a) comprises:
defining a high level circuit description in Chise; and
converting the higher level circuit description to Verilog for at least one of synthesis or simulation.

7. The method of claim 1, wherein the prototyping the proposed microarchitecture comprises;
prototyping the microarchitecture in a simulated environment, wherein the executing at least one μBenchmark on the prototyped microarchitecture and the monitoring at least one PMC are are performed within the simulated environment.

8. The method of claim 1, wherein the prototyping the proposed microarchitecture comprises:
synthesising the microarchitecture, wherein the executing at least one μBenchmark on the prototyped microarchitecture and the monitoring at least one PMC are performed on the synthesised microarchitecture.

9. The method of claim 8, wherein the synthetized microarchitecture is a Custom System on Chip, SoC, and prototyped in a field-programmable gate array, FPGA, circuit.

10. The method of claim 1, wherein the initial microarchitecture is proposed based on at least one of the following requirements:
Type of core, Core size, Number of cores, floating-point unit, Custom instructions, Cache size, level 2 cache, double data rate controller, memory management unit, physical memory protection, tightly coupled memory, On-chip scratchpad memory, Branch prediction capabilities, Number of PMCs, Redundancy on memory-mapped input/outputs, Memory Mapped, MM, peripherals for processing, or MM peripherals for communication and actuation.

11. The method of claim 1, wherein at least one of the following are monitored:
cache hits and misses, number of instructions retired, number of clock cycles, number and types of transactions through the system bus, number of cycles the HW resource has been idle, stalled, or busy.

12. The method of claim 1, wherein the at least one μBenchmark is selected from a database of μBenchmarks.

13. (canceled)

14. (canceled)

15. (canceled)
